(19) United States
(12) Patent Application Publication
(10) Pub. No.: US 2008/0145036 A1
(43) Pub. Date: Jun. 19, 2008

(54) Digital disc player with last play position memory

(75) Inventor: Zhong-Ru Li, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/002,364

(22) Filed: Dec. 17, 2007

(30) Foreign Application Priority Data
Dec. 15, 2006 (TW) 95147257

(51) Int. Cl. H04N 7/26

(52) U.S. Cl. 386/124; 386/E05.064

(57) ABSTRACT

An exemplary digital disc player includes a main control unit (21), a central processing unit (28) and a detecting circuit (24). The central processing unit includes a controller (282) and a first storage unit (283). The detecting circuit is configured for detecting a variation of a voltage of the main control unit and the central processing unit. When the power of the digital disc player is cut off, the detecting circuit generates a temporary direct voltage, the first storage storing track information of a digital disc. When the power of the digital disc player is turned on again, the main control unit addresses the track information from the first storage unit according to a control signal from the controller.

### FIELD OF THE INVENTION

The present invention relates to a digital disc player with a resuming-playback function in which, when the power is suddenly turned off during playback, the last play position is stored in memory, and when the power is turned on again, playback can be resumed from the last play position.

### GENERAL BACKGROUND

With the digital trend spread globally, digital disc players are being used more and more. During recent years there has been a steady improvement in digital disc players. In general, a digital disc can store a huge amount of data including audio information and video information. The audio and video information maybe encoded, compressed information.

Referring to FIG. 2, a typical digital disc player 10 includes a main control unit (MCU) 11, a central processing unit (CPU) 18, a display circuit 14, an audio circuit 31, a disc reader 15, a data circuit 16, and a decode circuit 17.

The disc reader 15 includes an optical pickup configured for irradiating a light beam onto a recording surface of a digital disc (not shown) and receiving the reflected light, a spindle motor configured for rotating the digital disc, and a servo control mechanism configured for controlling an irradiation spot of the light beam and the rotation of the spindle motor. The disc reader 15 is used to read a signal including audio information and video information recorded in the digital disc, and output the signal to the data circuit 16 in response to an instruction from the MCU 11. In addition, the disc reader 15 can continuously transfer track information of the digital disc to the MCU 11. The track information indicates a virtual position where the digital disc is read. That is, the track information represents from where the digital disc is played.

The data circuit 16 is used to amplify the read signal from the disc reader 15, and output an amplified signal to the decode circuit 17. In addition, the data circuit 16 performs various digital signal processing functions such as error-correction processing, and separating processing of video information from processing of audio information.

The decode circuit 17 is used to decode the signal including the audio and video information output from the data circuit 16, and transfer a decoded audio signal to the audio circuit 31 and a decoded video signal to the display circuit 14. The audio circuit 31 provides the decoded audio signal to a speaker (not shown) or a like sound output device. The display circuit 14 provides the decoded video to a display device 32 such as a liquid crystal display, a plasma display panel or the like.

The CPU 18 includes a selector 181, a controller 182, and a storage unit 183. The selector 181 serves as a user interface for a user to input a command to the digital disc player 10. The selector 181 generates an instruction signal representing the input command, and outputs the instruction signal to the controller 182. For example, the instruction signal can be for the digital disc player 10 to remember a last play position of the digital disc before the digital disc player 10 is turned off. The controller 182 generates a storing signal in response to the instruction signal, and sends the instruction signal to the storage unit 183. Then, the storage unit 183 stores the track information of the digital disc obtained from the MCU 11. Thus, after being turned off by a user intentionally, the digital disc player 10 can recall a play position of the digital disc when the digital disc player 10 is turned on again. In detail, when the digital disc player 10 is turned on again, the CPU 18 outputs a message signal to the display circuit 14. On receiving the message signal, the display circuit 14 generates a display signal, and outputs the display signal to the display device 32. The display device 32 then displays a message like “RESUME PLAYBACK, YES OR NO”. The user can then select the resume playback mode by inputting an instruction through the selector 181. If the user chooses “YES”, the controller 182 accordingly sends an addressing signal to the MCU 11. The MCU 11 reads the track information stored in the storage unit 183 on receiving the addressing signal, and drives the disc reader 15 to read the digital disc from the play position recorded in the track information. Thus, the digital disc player 10 plays the digital disc from the last play position.

However, the digital disc player 10 can only resume a playback from the last play position if the user has preset the digital disc player 10 to remember the last play position. In other words, when the digital disc player 10 is turned off unexpectedly, the digital disc player 10 is not capable of resuming a playback from the last play position. This situation typically arises when the power supplied to the digital disc player 10 is suddenly turned off by accident.

What is needed, therefore, is a digital disc player that can overcome the above-described deficiencies.

### SUMMARY

In one preferred embodiment, a digital disc player includes a main control unit, a central processing unit and a detecting circuit. The central processing unit includes a controller and a first storage unit. The detecting circuit is configured for detecting a variation of a voltage of the main control unit and the central processing unit. When the power of the digital disc player is cut off, the detecting circuit generates a temporary direct voltage, the first storage storing track information of a digital disc. When the power of the digital disc player is turned on again, the main control unit addresses the track information from the first storage unit according to a control signal from the controller.

Other aspects, novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views.

FIG. 1 is a block diagram of a digital disc player according to an exemplary embodiment of the present invention.

FIG. 2 is a block diagram of a conventional digital disc player.

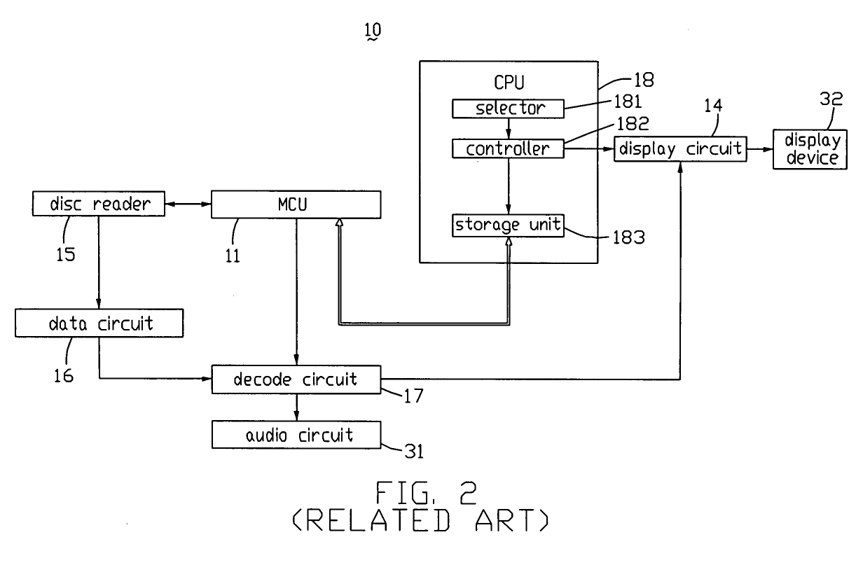

### DETAILED DESCRIPTION OF PREFERRED EMBODIMENTS

Reference will now be made to the drawings to describe preferred and exemplary embodiments in detail.

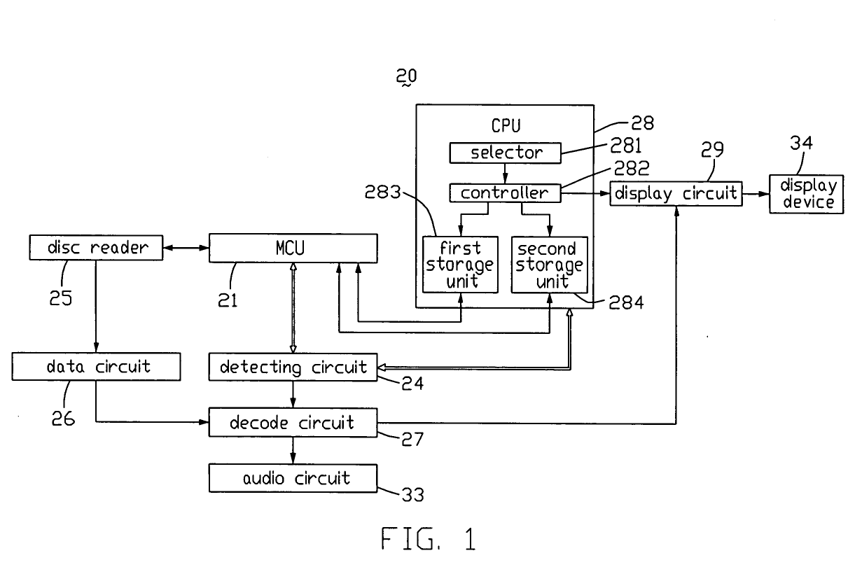

Referring to FIG. 1, a digital disc player 20 according to an exemplary embodiment of the present invention is shown. The digital disc player 20 includes an MCU 21, a disc reader 25, a data circuit 26, a decode circuit 27, a detecting circuit 24, a CPU 28, a display circuit 29, and an audio circuit 33.

The disc reader 25 includes an optical pickup for irradiating a light beam onto a recording surface of a digital disc (not shown) and receiving the reflected light, a spindle motor configured for rotating the digital disc, and a servo control mechanism configured for controlling an irradiation spot of the light beam and the rotation of the spindle motor. The disc reader 25 is used to read a signal including the audio information and the video information recorded in the digital disc, and output the read signal to the data circuit 16 in response to an instruction from the MCU 21. In addition, the disc reader 25 can continuously transfer track information of the digital disc to the MCU 21. The track information indicates a virtual position where the digital disc is read. That is, the track information represents from where the digital disc is played.

The data circuit 26 is used to amplify the read signal from the disc reader 25, and output an amplified signal to the decode circuit 27. In addition, the data circuit 26 performs various digital signal processing functions such as error-correction processing, and separating processing of video information from processing of audio information.

The decode circuit 27 is used to decode the signal including the audio and video information output from the data circuit 26, and transfer a decoded audio signal to the audio circuit 33 and a decoded video signal to the display circuit 29. The audio circuit 33 provides the decoded audio signal to a speaker (not shown) or a like sound output device. The display circuit 29 provides the decoded video to a display device 34 such as a liquid crystal display, a plasma display panel or the like.

The CPU 28 includes a selector 281, a controller 282, a first storage unit 283, and a second storage unit 284. The selector 281 serves as a user interface for a user to input a command to the digital disc player 20. The selector 281 generates an instruction signal representing the input command, and outputs the instruction signal to the controller 282. In a normal situation, the MCU 21 keeps outputting track information to the first and second storage units 283, 284, but the track information is not stored in the first and second storage units 283, 284.

When the user provides a storing instruction to the selector 281 at a moment in time, say “T1”, the selector 281 outputs the corresponding instruction signal to the controller 282. The controller 282 generates a storing signal, and sends the storing signal to the second storage unit 284. Then, the second storage unit 284 stores the track information obtained from the MCU 21.

The detecting circuit 24 is capable of detecting a variation in a voltage applied to the CPU 28 and the MCU 21. When the digital disc player 20 is working, the detecting circuit 24 outputs a low voltage (to the MCU 21 and the CPU 28. If the power is cut off suddenly at a later moment in time, say “T2”, the detecting circuit 24 can detect the voltage drop of the CPU 28 and the MCU 21, and generate a temporary direct voltage. The controller 282 automatically generates a storing signal, and sends the storing signal to the first storage unit 283. Thus the first storage unit 283 stores the track information before the temporary direct voltage is cut off.

When the digital disc player 20 is turned on again, the CPU 28 outputs a message signal to the display circuit 29. On receiving the message signal, the display circuit 29 generates a display signal, and outputs the display signal to the display device 34. The display device 34 then displays a message like:
“RESUME PLAYBACK 1, YES OR NO
RESUME PLAYBACK 2, YES OR NO”

The user can then select a playback mode by inputting an instruction through the selector 281. If the user chooses “YES” for “RESUME PLAYBACK 1”, the controller 182 accordingly sends a first addressing signal to the MCU 11. The MCU 11 reads the track information stored in the second storage unit 284 on receiving the first addressing signal, and drives the disc reader 25 to read the digital disc from the play position recorded in the track information. Thus, the digital disc player 10 plays the digital disc from the play position set by the user.

If the user chooses “YES” for “RESUME PLAYBACK 2”, the controller 282 accordingly sends a second addressing signal to the MCU 21. The MCU 21 reads the track information stored in the first storage unit 283 on receiving the second addressing signal, and drives the disc reader 25 to read the digital disc from the play position recorded in the track information. Thus, the digital disc player 20 plays the digital disc from the last play position at the time the power was cut off suddenly.

In summary, the digital disc player 20 is able to not only resume a playback as set by the user, but also resume a playback even when the power is cut off suddenly. In an alternative embodiment, such latter playback function can be provided even when the digital disc player 20 is intentionally powered off by the user.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A digital disc player comprising:
a main control unit (MCU);
a central processing unit (CPU) comprising a controller and a first storage unit; and
a detecting circuit configured for detecting a voltage variation of at least one of the MCU and the CPU;
wherein when the power of the digital disc player is cut off, the detecting circuit generates a temporary direct voltage, the controller automatically generates a store signal and sends the store signal to the first storage unit, and the first storage unit stores track information of a playing digital disc according to the store signal; and
when the power of the digital disc player is turned on again, the MCU addresses the track information from the first storage unit according to a control signal received from the controller.

2. The digital disc player in claim 1, further comprising a disc reader, the disc reader comprising:
an optical pickup for irradiating a light beam onto a recording surface of the digital disc and receiving the reflected light;
a spindle motor for rotating the digital disc; and
a servo control mechanism for controlling an irradiation spot of the light beam and the rotation of the spindle motor.

3. The digital disc player in claim 2, wherein the disc reader is configured for reading the digital disc from a play position according to the track information obtained from the MCU.

4. The digital disc player in claim 2, further comprising a data circuit configured for amplifying a read signal provided from the disc reader.

5. The digital disc player in claim 4, wherein the data circuit is further configured for correcting errors of the read signal, and separating video information of the read signal from audio information of the read signal.

6. The digital disc player in claim 4, further comprising a decode circuit, an audio circuit, and a video circuit, wherein the decode circuit is configured for decoding the signal comprising video information and audio information, and transferring a decoded video signal to the video circuit and a decoded audio signal to the audio circuit.

7. The digital disc player in claim 6, wherein the video circuit outputs the decoded video signal to a display device.

8. The digital disc player in claim 6, wherein the audio circuit outputs the decoded audio signal to a speaker.

9. The digital disc player in claim 1, wherein the CPU further comprises a second storage unit configured for storing track information of a playing digital disc according to a control signal generated by the controller in response to a user instruction.

10. The digital disc player in claim 9, wherein the CPU further comprises a selector configured for receiving the user instruction and outputting a corresponding user instruction signal to the controller.

11. The digital disc player in claim 9, wherein the MCU outputs track information to the first and second storage units continuously.

12. A digital disc player comprising:
a main control unit (MCU);
a central processing unit (CPU) comprising a controller, and a first storage unit and a second storage unit, each of said first storage and said second storage respectively connected to the controller and the MCU; and
a detecting circuit connected to the MCU and the CPU, and configured for detecting a voltage variation of at least one of the MCU and the CPU.
